(19) United States
(12) Patent Application Publication
(10) Pub. No.: US 2014/0304720 A1
(43) Pub. Date: Oct. 9, 2014

(54) METHOD FOR STARTING PROCESS OF APPLICATION AND COMPUTER SYSTEM

(71) Applicant: Tencent Technology (Shenzhen) Company Limited, Shenzhen (CN)

(72) Inventors: Xiao Yu, Shenzhen (CN); Xuezhou Liao, Shenzhen (CN); Fen'an Ou, Shenzhen (CN)

(21) Appl. No.: 14/304,590

(22) Filed: Jun. 13, 2014

Related U.S. Application Data
(63) Continuation of application No. PCT/CN2013/089704, filed on Dec. 17, 2013.

(30) Foreign Application Priority Data
Apr. 3, 2013 (CN) 201310115475.0

(51) Int. Cl. G06F 9/445

(52) U.S. Cl. CPC G06F 9/44521
USPC 719/331

(57) ABSTRACT

A method and a computer system are provided for starting a process of an application. When starting the application, the computer system may load a second dll file by default. However, in instances when a first dynamic link library file is to be injected into the process, a driving module adds information about the first dynamic link library file into an import table of the second dynamic link library file. The second dynamic link library file that includes the import table with the added information of the first dynamic link library is loaded into memory. In this manner, the default-loading mechanism of the system is bypassed, and the first dll file is injected by modifying the import table of the second dll file before it is loaded into memory. Therefore, it is not required to load the first dll file while executing the process of the application.

This application is a continuation application of International Application No. PCT/CN2013/089704, filed on Dec. 17, 2013, which claims the priority to Chinese Patent Application No. 201310115475.0, filed Apr. 3, 2013 in the Chinese Patent Office, entitled “METHOD FOR STARTING PROCESS OF APPLICATION AND COMPUTER SYSTEM,” both of which are incorporated by reference herein in their entireties.

### FIELD

The disclosure relates to the field of computer technique, and particularly to a method for starting a process of an application and a computer system.

### BACKGROUND

When starting a process of an application, a computer system may load Portable Executable (PE) files, such as, for example, an exe file and a dll file that corresponds to the process of the application. A PE file in exe format may be an executable file and may be referred to as an exe file. A PE file in dll format may be a dynamic link library file and may be referred to as a dll file.

For a process of an application that has a special architecture, for example, a .net architecture, when the computer system executes a loaded exe file, a third-party application module may inject an import function into the process of the application by the way of shell code, hook or other methods, where executable code of the import function may be located in one or more dll files. In this manner, the import function may be a function to be called, and executable code of the import function is not loaded in the exe file. In this way, the starting of the process of the application may be achieved. However, when using this method, execution of the process of the application may be unstable, or the action of injecting codes during execution may be considered a dangerous operation and may be intercepted.

### SUMMARY

A method for starting a process of an application and a computer system are provided according to embodiments of the disclosure. The method and computer system effectively perform an injection on the process of the application and ensure stability of execution of the process of the application with this architecture.

A method for starting a process of an application is provided according to an embodiment of the disclosure. The method includes:

loading into memory, an executable file that corresponds to the process of the application wherein the executable file is operable to call a second dynamic link library file;

adding information of a first dynamic link library file into an import table of the second dynamic link library file in instances when it is determined that the first dynamic link library file is to be injected into the process; and
loading into memory the second dynamic link library file that includes the import table with the added information of the first dynamic link library.

A computer system is provided according to an embodiment of the disclosure. The computer system includes:

an executable file loading unit adapted to load into memory an executable file that corresponds to the process of the application wherein the executable file is operable to call a second dynamic link library file;

an information adding unit adapted to add information of a first dynamic link library file into an import table of the second dynamic link library file in instances when it is determined that the first dynamic link library file is to be injected into the process; and

a dynamic link library file loading unit adapted to load into memory the second dynamic link library file that includes the import table with the added information of the first dynamic link library.

In some embodiments of the disclosure, during a starting procedure for a process of an application, when a computer system loads an exe file corresponding to the process of the application, the computer system may default to loading a second dll file, rather than an import table of the exe file itself. In instances when it is determined that a first dll file may be injected into the process, a driving module at a bottom layer of the computer system may modify an import table of the second dll file which is loaded by default, and then the computer system may load this second dll file into memory. In this way, the default-loading mechanism of the system may be bypassed, and the first dll file may be injected by modifying the import table of the second dll file. Thus, it is ensured that when the process of the application is executed, all the functions required are already loaded into the memory, and the process of the application is effectively injected with the first dll file. Furthermore, in the embodiments of the disclosure, instead of loading the first dll file during execution of the codes of the process of the application, a universal flow for injected files is used. Thus, compared with injection of a dll file using shell code or a hook as in the prior art, stability in execution of the process of the application may be improved.

### BRIEF DESCRIPTION OF THE DRAWINGS

The present disclosure may be better understood with reference to the following drawings and descriptions which include non-limiting and non-exhaustive embodiments of the disclosure. The drawings described hereinafter include only some embodiments related to the present disclosure. Other drawings may be determined by those skilled in the art based on these drawings, without creative effort.

FIG. 1 is a flow chart of a method for starting a process of an application according to an embodiment of the disclosure.

FIG. 2 is a flow chart of a method for starting a process of an application according to an embodiment of the disclosure.

FIG. 3 is a flow chart of a method for starting a process of an application according to an embodiment of the disclosure.

FIG. 4 is a schematic structural diagram of a computer system according to an embodiment of the disclosure.

FIG. 5 is a schematic structural diagram of a computer system according to an embodiment of the disclosure.

FIG. 6 is a schematic structural diagram of a computer system according to an embodiment of the disclosure.

FIG. 7 is a schematic structural diagram of a terminal which is operable to perform a method for starting a process of an application according to an embodiment of the disclosure.

### DETAILED DESCRIPTION OF EMBODIMENTS

Several embodiments of the disclosure will be described in conjunction with the accompanying drawings. All other embodiments determined by those skilled in the art based on the embodiments of the present disclosure, without creative effort, will fall within the scope of protection of the present disclosure.

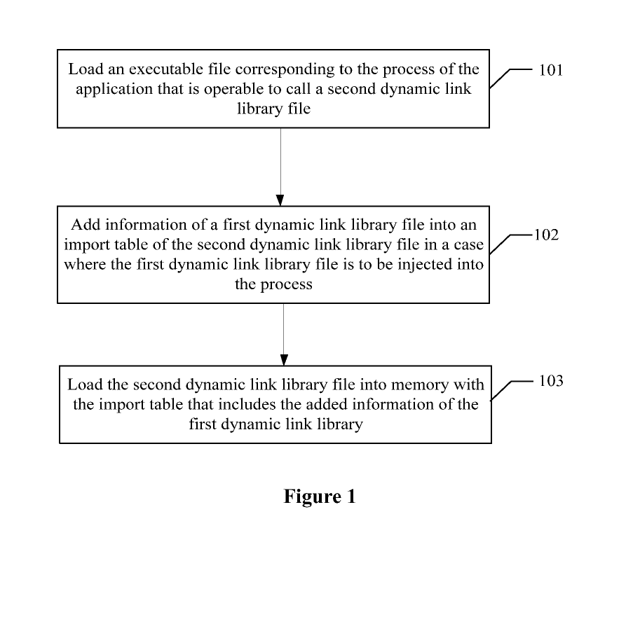

A method for starting a process of an application is provided according to an embodiment of the disclosure, the method may be executed by a computer system that may include a hardware system and a software system. The software system may include an application software system and an operating system. The application software system may include a driving module. Both the hardware system and the software system may include a storage module. A flow of the method according to an embodiment of the disclosure is described with respect to FIG. 1, which may include exemplary steps 101-103.

In step 101, an executable file that corresponds to a process of an application may be loaded into memory and may be operable to call a second dynamic link library file. Further, it may be determined whether a first dynamic link library file is to be injected into the process. In instances when the first dynamic link library file is to be injected, the flow of the method may jump out of the step 101 and proceed to step 102.

In step 102, information of a first dynamic link library file may be added into an import table of the second dynamic link library file in instances when the first dynamic link library file is to be injected into the process.

In step 103, the second dynamic link library file with the added import table may be loaded into memory.

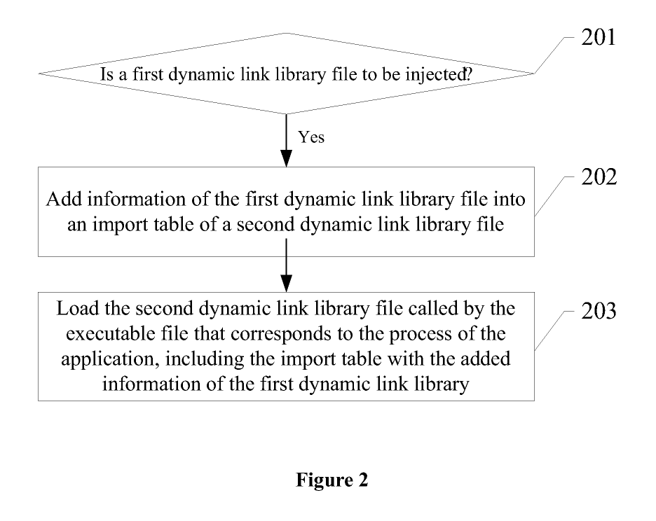

Referring to FIG. 2, a method for starting a process of an application is provided in accordance with an embodiment of the disclosure. The method may include exemplary steps 201-203.

In Step 201, when the computer system loads the executable file, in other words an exe file, which corresponds to the process of the application, a driving module of the computer system may firstly determine whether a first dynamic link library file, in other words a first dll file, is to be injected. In instances when the first dll file is to be injected, the exemplary steps may proceed to step 202. Otherwise the driving module of the computer system may default to loading directly a second dynamic link library file, for example, a file such as the dynamic link library files named mscoree or kernel32, rather than loading an import table of the exe file that corresponds to the process of the application. In this manner, the computer system may not determine the dll file to be loaded according to the import table of the exe file itself. The second dynamic link library file may also include dll files in other forms, the detail of which is not repeated here.

The term process of the application may refer to an active application. For example, the driving module may have loaded code of the application into memory. The code may be stored in the exe files and the dll files. In other words, the application code has been put into a storage module of a corresponding computer system and occupies system resources. An application may be referred to as “program” before it is called into a memory space, and may be referred to as “process” after being called into the memory space and having resources assigned. Each application may be stored in a corresponding memory space segment of the storage module.

It may be understood that when a process of an application is started, the driving module may register a callback function for loading the exe file corresponding to the process of the application, to the operating system of the computer system. That is, the driving module may transmit information of the callback function for loading the exe file, to the operating system of the computer system. The information of the callback function may include address information. The operating system of the computer system may execute the callback function. For example, the operating system may load the exe file into the computer memory that may be referred to as a storage module. In this procedure, the driving module may determine whether the first dll file is to be injected. Specifically, the driving module may determine whether the execution of the process of the application utilizes an import function, for example, a called function whose execution codes are not in the exe file. In instances when the execution of the process of the application utilizes an import function, the operating system of the computer system may continue to execute the step of loading the exe file. Otherwise, since execution code of the import function may be stored in one or more dll files, the first dll file may be rejected for storing the import function.

In Step 202, the driving module of the computer system may add information of the first dynamic link library file into the import table of the second dynamic link library file.

For the processes of some applications, when the first dll file is injected, the driving module will modify the import table of the exe file itself corresponding to the process of the application. In this regard, the information of the first dll file to be injected may be added into the import table of the exe file itself. Then, the operating system of the computer system may load the first dll file and the exe file according to the import table that includes the added information of the first dll file. The import table may include a correspondence between information of the function to be used, for example, name information, etc., and information of the file for storing the function, for example, name information, path information, etc.,. For example, the import table may include the information of the import function and the information of the dll file for storing the import function. In this way, the computer system knows which dll file is to be loaded.

For processes of other applications, for example, a process of an application with a .net architecture, when the first dll file is injected, the driving module in the computer system may modify the import table of the second dynamic link library file that may be default-loaded when the exe file is loaded. That is, the information of the first dll file to be injected may be added into the import table of the second dll file. In a specific implementation, the driving module may firstly construct a new import table, and insert path information for the dll file to be loaded (including the first dll file) into this new import table; and then modify the pointer of the original import table of the second dll file to point the pointer of the original import table of the second dll file to the new import table inserted with the path information. The driving module may also insert into the new import table other information of the first dll file to be loaded, such as information of the import table stored in the first dll file.

The process applied to the .net architecture and the process applied to the architecture other than the .net architecture described above, refer to processes of two types of the applications with different programming ways.

In Step 203, the operating system of the computer system may load the second dynamic link library file called by the executable file that corresponds to the process of the application, according to the import table with the added information of the first dynamic link library file.

It should be noted that when executing the above step 202, the driving module may modify the import table of the second dll file. For example, the second dll file may include the dynamic link library file named as mscoree, or the dynamic link library file named as kernel32. In this way, when the operating system of the computer system performs the step 203, the step of loading the second dll file with the modified import table includes: loading, to the storage module such as the memory, all of the second dll file, the first dll file injected into the second dll file and other dll files to be injected according to the modified import table. However, the step for loading the second dll file with the import table which is not modified includes: loading the second dll file into the memory according to the import table of the second dll file itself

During starting of the process of the application, when loading the exe file that corresponds to the process of the application, the computer system may default to load the import table of the second dll file, rather than the import table of the exe file itself. In the embodiments of the disclosure, in instances when the first dll file is to be injected, the driving module at the bottom layer of the computer system may modify the import table of the second dll file default-loaded, and then the operating system of the computer system may reload this second dll file. In this way, the default-loading mechanism of the system is bypassed, and the first dll file may be injected by modifying the import table of the second dll file. This method may ensure that all the functions required in the execution of the process of the application are loaded into the memory, and the process of the application is effectively injected. Furthermore, in the embodiments of the disclosure, it is not required to load the first dll file during executing the codes of the process of the application, and a universal flow for injecting files may be used. Thus, compared with the injection of a dll file by using shell code or hook in the prior art, the stability of the execution of the process of the application may be ensured.

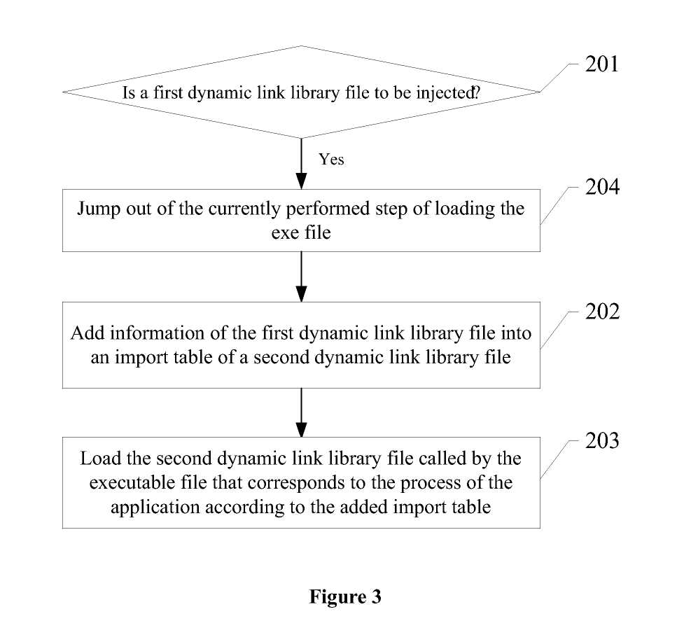

In a specific implementation of starting the process of the application described above, for the security of the process of the application, when loading the PE file corresponding to the process of the application, the computer system may lock the memory space for the process of the application to prevent the loaded PE file from being modified. In this case, the import table of the second dll file to be modified by the above driving module may also be locked. Thus, the above step 202 can not be performed. Referring to FIG. 3, in this case, the driving module may perform the step 204 before the step 202. The step 204 includes: triggering the computer system to jump out of the currently performed step of loading the executable file corresponding to the process of the application. The step 204 further includes: jumping out of a callback function for loading the PE file, which is currently executed by the operating system of the computer system. In this way, the memory space for the process of the application, in other words, a space segment in the storage module may not be in a locked protection status, and the driving module may modify the import table of the second dll file. Then, the operating system of the computer system may return to the currently executed function, and perform the steps 202 and 203. When the driving module triggers the computer system to jump out of the currently performed step, an asynchronous procedure call (APC) function may firstly be inserted into the executable program for staring the process of the application, and the operating system of the computer system may execute the APC function.

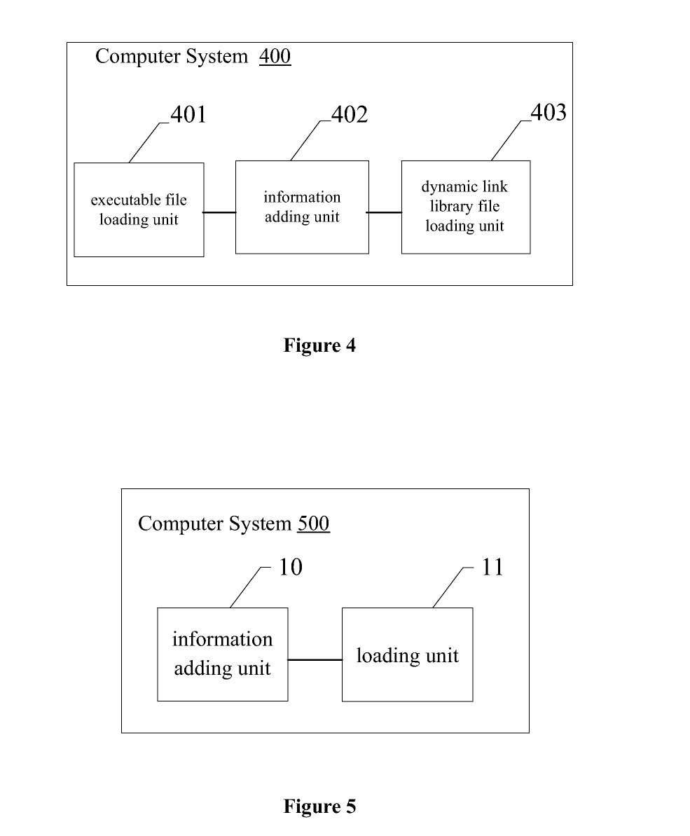

A computer system is provided according to an embodiment of the disclosure, which is a device for starting a process of an application. A schematic structural diagram of the computer system is shown in FIG. 4, which includes a computer system 400, an executable file loading unit 401, an information adding unit 402, and a dynamic link library file loading unit 403.

The executable file loading unit 401 may be adapted to load an executable file that corresponds to the process of the application, to call a second dynamic link library file. The executable file loading unit 401 may further include a determining unit (not shown) adapted to determine that the first dynamic link library file is to be injected; and a jumping unit adapted to jump out of the step of loading an executable file corresponding to the process of the application.

The determining unit may be further adapted to determine whether an import function is applied to an execution of the process of the application, and determine the first dynamic link library file injected with the import function in the case that the import function is applied to the execution of the process of the application. The jumping unit may insert an asynchronous procedure call function into an execution program of loading the executable file by the executable file loading unit; and the executable file loading unit 401 may be further adapted to perform the asynchronous procedure call function.

The information adding unit 402 may be adapted to add information of a first dynamic link library file into an import table of the second dynamic link library file in the case that the first dynamic link library file is to be injected.

The dynamic link library file loading unit 403 may be adapted to load the second dynamic link library file that includes the import table with the added information.

In an embodiment of the disclosure, another computer system 500 for starting a process of an application is provided, as shown in FIG. 5. The computer system 500 may include an information adding unit 10 and a loading unit 11. The process of the application may be started by these units according to the method described in the above embodiments.

The information adding unit 10 may be adapted to, when the loading unit 11 loads an executable file corresponding to the process of the application, in instances when a first dynamic link library file is to be injected, add information of the first dynamic link library file into an import table of a second dynamic link library file. The second dll file may be any dll file which may be default-loaded when the loading unit 11 loads the exe file. For example, the second dll file may include the dynamic link library named as mscoree. When loading the executable file corresponding to the process the application, the information adding unit 10 may determine whether the execution of the process of the application utilizes an import function; and may determine the first dynamic link library file for storing the import function in the case that the execution of the process of the application utilizes an import function.

The loading unit 11 may be adapted to load the executable file corresponding to the process of the application, and load the second dynamic link library file called by the executable file according to the import table added by the information adding unit 10. Specifically, when loading the second dll file with the modified import table, the loading unit 11 may be required to load into the memory all of the second dll file, the first dll file injected into the second dll file and other dll files to be injected according to the modified import table. However, when loading the second dll file with the import table which is not modified, the loading unit 11 may load the second dll file into the memory according to the import table of the second dll file itself

It should be noted that the information adding unit 10 described above may also be applied to the processes of the applications with the architecture other than the .net architecture. The information adding unit 10 may modify the import table of the exe file corresponding to the process of the application when the first dll file is to be injected. Specifically, the information of the first dll file to be injected may be added into the import table of the exe file itself; and then the loading unit 11 may load the first dll file and the exe file according to the import table with the added information of the first dll file.

During starting a process of an application, when the computer system loads the exe file corresponding to the process of the application, the computer system defaulted-loads the second dll file, rather than the import table of the exe file itself. In some embodiments of the disclosure, in instances when the first dll file is to be injected, the information adding unit 10 may modify the import table of the second dll file default-loaded, and then the adding unit 11 may load the second dll file. In this way, the default-loading mechanism of the system is bypassed, and the dll file may be injected by modifying the import table. This way may ensure that all the functions required in the execution of the process of the application are loaded into the memory, and the process of the application is effectively injected. Furthermore, in the embodiments of the disclosure, it is not required to load the first dll file during executing the codes of the process of the application, and a universal flow for injecting files may be used. Thus, compared with the injection of the dll file by using shell code or hook in the prior art, the stability of the execution of the process of the application can be ensured.

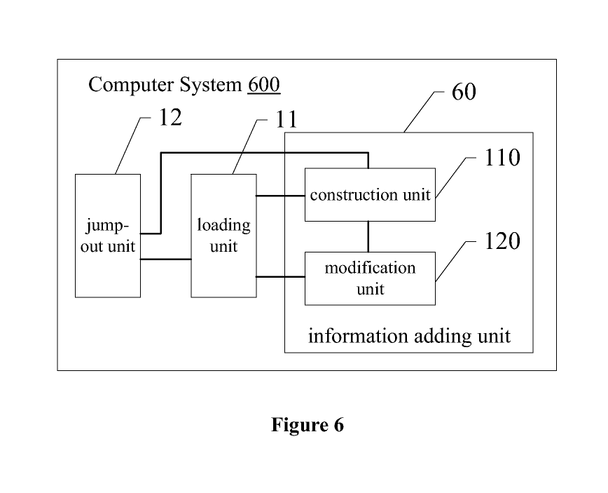

FIG. 6 is a schematic structural diagram of a computer system according to an embodiment of the disclosure. Referring to FIG. 6, for a specific embodiment, in addition to the structure shown in FIG. 5, a computer system 600 may include a jump-out unit 12, and for the specific embodiment, the information adding unit 10 may comprise the adding unit 60 that may include a construction unit 110 and an adding unit 120.

The jump-out unit 12 may be adapted to trigger the loading unit 11 to jump out of the step of loading the executable file that corresponds to the process of the application. After the jump-out unit 12 triggers the loading unit 11 jumps out of the currently performed step, the information adding unit 60 may perform the step of the adding information of the first dynamic link library file. Specifically, the jump-out unit 12 may insert an APC function into the execution program for loading the exe file by the loading unit 11, and then the loading unit 11 may execute the APC function.

The construction unit 110 may be adapted to, when the loading unit 11 loads an executable file corresponding to the process of the application, in instances when the first dynamic link library file is to be injected, construct a new import table, and insert into the new import table, path information of a dynamic link library file to be loaded. The dynamic link library file to be loaded may include the first dynamic link library file.

The modification unit 120 may be adapted to modify a pointer of an original import table of the second dynamic link library file to point the pointer of the original import table of the second dynamic link library file to the new import table constructed by the construction unit 110 and inserted with the path information.

In the system of the embodiments, when the loading unit 11 loads the executable file corresponding to the process of the application, in instances when a first dynamic link library file is to be injected, the jump-out unit 12 may trigger the loading unit 11 to firstly jump out of the currently performed step of loading the exe file. Then, the construction unit 10 in the information adding unit 60 may construct a new import table. After the modification unit 120 modifies the original import table of the second dll file, the loading unit 11 may continue to perform the step of loading.

It should be noted that, in practical application, both the information adding unit 10 or 60 and the jump-out unit 12 in the computer system belong to parts of the driving module at the bottom layer. The loading unit 11, which may be adapted to load the exe file and the dll file, may include parts of the driving module at the bottom layer and parts of the application module at the upper layer.

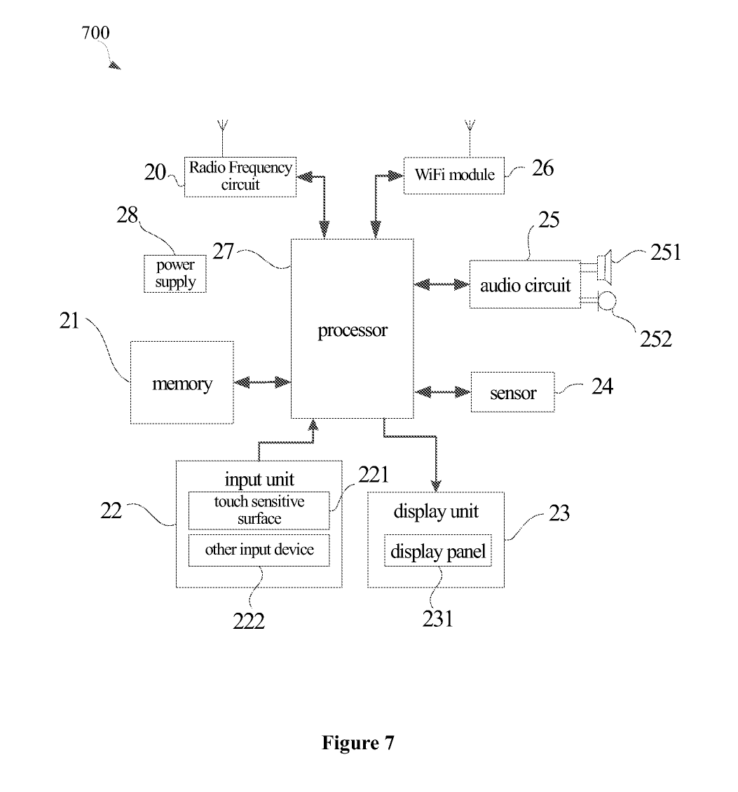

FIG. 7 is a schematic structural diagram of a terminal which is operable to perform a method for starting a process of an application according to an embodiment of the disclosure. In the following example, the method for starting a process of an application according to the embodiments of the present disclosure is applied to a terminal. The terminal may be a smart phone, a panel computer, an ebook reader, a Moving Picture Experts Group Audio Layer III (MP3) player, a Moving Picture Experts Group Audio Layer IV (MP4) player, a laptop portable computer, a desktop computer and so on.

Referring to FIG. 7, there is shown a terminal 700 that may include: a Radio Frequency (RF) circuit 20, a memory 21 including one or more computer readable storage mediums, an input unit 22, a display unit 23, a sensor 24, an audio circuit 25, a wireless fidelity (WiFi) module 26, a processor 27 including one or more processing cores, a power supply 28 and so on. Those skilled in the art may understand that the terminal is not limited to the specific structure shown in FIG. 7, and may include more or fewer components than those illustrated, a combination of the components, or a different arrangement of the components.

The RF circuit 20 may be adapted to receive and send information, or receive or send a signal in a calling procedure. Specifically, the RF circuit 20 may receive downlink information from a base station, and send the information to one or more processors 27 for processing. In addition, the RF circuit 20 may send uplink data to the base station. The RF circuit 20 may include but is not limited to an antenna, at least one amplifier, a tuner, one or more oscillators, a Subscriber Identity Module (SIM) card, a transceiver, a coupler, a Low Noise Amplifier (LNA), a duplexer and so on. Furthermore, the RF circuit 20 may also communicate with a network or other devices via wireless communication. The wireless communication may be operated in any communication standard or protocol, which may include but is not limited to Global System of Mobile communication (GSM), General Packet Radio Service (GPRS), Code Division Multiple Access (CDMA), Wideband Code Division Multiple Access (WCDMA), Long Term Evolution (LTE), e-mail, Short Messaging Service (SMS) and so on.

The memory 21 may be adapted to store software programs or modules. The processor 27 may be adapted to perform various function application and data processing by running the software programs or modules stored in the memory 21. The memory 21 may include a program memory area and a data memory area. The program memory area may store an operating system, an application utilized by at least one function, for example, a sound playing function or an image playing function and so on. The data memory area may store data, for example, audio data or a phone book, which may be created according to terminal utilization, and so on. Furthermore, the memory 21 may be a high speed random access memory, and may also be a nonvolatile memory, for example, at least one magnetic disk memory device, a flash memory device or other volatile solid state memory device. Accordingly, the memory 21 may also include a memory controller for providing access of the processor 27 and the input unit 22 to the memory 21.

The input unit 22 may be used to receive digital information or character information that is input, and generate signals input by a keyboard, a mouse, a joystick or a trackball, which relate to user settings and function control. Specifically, in an embodiment, the input unit 22 may include a touch-sensitive surface 221 and other input devices 222. The touch-sensitive surface 221, also referred to as a touch display screen or a touch panel, may collect touch operations provided by a user thereon or in the vicinity thereof, such as operations made by the user using any suitable object or accessory, for example, a finger and a touch pen, on the touch-sensitive surface 221 or in the vicinity of the touch-sensitive surface 221; and then may drive a corresponding connection device according to a program set in advance. Optionally, the touch-sensitive surface 221 may include a touch detection device and a touch controller. Specifically, the touch detection device may detect the touch position of the user and a signal caused by the touch operation, and may send the signal to the touch controller. The touch controller may receive the touch information from the touch detection device, convert the information into coordinates of the touch point, then send the coordinates of the touch point to the processor 27, and may receive a command sent from the processor 27 to perform. Furthermore, the touch-sensitive surface 221 may be realized in multiple ways, for example, as in a resistive type, a capacitive type, an infrared type and a surface acoustic wave type. In addition to the touch-sensitive surface 221, the input unit 22 may also include other input devices 222. Specifically, the other input devices 222 may include but not limited to one or more of a physical keyboard, a function key (such as a volume control button and a switch button), a trackball, a mouse, a joystick and so on.

The display unit 23 may be used to display information input by the user, information provided to the user and various graphical user interfaces of the terminal Those graphical user interfaces may include graphics, text, an icon, a video and any combination thereof. The display unit 23 may include a display panel 231. Optionally, the display panel 231 may be configured as, for example, a Liquid Crystal Display (LCD) or an Organic Light-Emitting Diode (OLED) display. Furthermore, the touch-sensitive surface 221 may cover the display panel 231. When the touch-sensitive surface 221 detects a touch operation thereon or in the vicinity thereof, the touch-sensitive surface 221 sends the detected touch operation to the processor 27 to determine a type of the touch event. The processor 27 then provides a corresponding visual output on the display panel 231 according to the type of the touch event. The touch-sensitive surface 221 and the display panel 231, which is shown as two separate components to realize the input function and the output function respectively in FIG. 7, may be integrated together to realize the input function and the output function in some embodiments.

The terminal may further include at least one sensor 24 such as a light sensor, a motion sensor and other sensors. Specifically, the light sensor may include an ambient light sensor and a proximity sensor. The ambient light sensor may adjust a brightness of the display panel 231 according to ambient light. The proximity sensor may turn off the display panel 231 and/or a backlight when the terminal is closed to the user's ear. As one of the motion sensors, a gravity acceleration sensor may detect an acceleration value in each direction (generally, in three axial directions), and detect a value and direction of the gravity in a stationary state. The gravity acceleration sensor may be applied to an application (such as orientation change, related games, magnetometer attitude calibration) for identifying the attitude of a cell phone, a function related to vibration identification (such as a pedometer, or a knock) and so on. Other sensors such as a gyroscope, a barometer, a hygrometer, a thermometer, an infrared sensor, which may be equipped to the terminal, will not be described here any more.

An audio interface between the user and the terminal may be provided by the audio circuit 25, a speaker 251 and a microphone 252. The audio circuit 25 may convert the received audio data into an electrical signal and transmit the electrical signal to the speaker 251, and the speaker 251 may convert the electrical signal into a sound signal to output. On the other hand, the microphone 252 may convert the collected sound signal into an electrical signal and sends the electrical signal to the audio circuit 25, and the audio circuit 25 may convert the received electrical signal into audio data and output the audio data to the processor 27 to process. The processed audio data is then sent to for, example, to another terminal via the RF circuit 20 or output to the memory 21 for further processing. The audio circuit 25 may also include an earphone jack to provide communication between a peripheral headphone and the terminal

The WiFi is a short range wireless transmission technology. The terminal may assist the user to send and receive e-mails, browse a webpage and access a streaming media and so on via the WiFi module 26. The WiFi module 26 may provide wireless broadband internet access to the user. Although the WiFi module 26 is illustrated in FIG. 7, it may be understood that the WiFi module 26 is not necessary in the terminal, and may be omitted without changing the scope of essence of the present disclosure.

The processor 27, as a control center of the terminal, may be adapted to connect each part of the terminal using various interfaces and lines, and may perform various functions of the terminal and data processing by running or executing the software program and/or the software module stored in the memory 21 and calling data stored in the memory 21, thus achieving the monitor of the whole terminal Optionally, the processor 27 may include one or more processing cores. Preferably, an application processor and a modem processor may be integrated into the processor 27. In the processor 27, the application processor mainly processes the operating system, user interfaces, applications and so on. The modem processor mainly processes wireless communication. It may be understood that the modem processor described above may not be integrated into the processor 27.

The terminal may further include the power supply 28, for example, a battery, for supplying power to each component. Preferably, the power source may be logically connected to the processor 27 via a power supply management system, thus achieving functions such as charge management, discharge management, power consumption management by the power supply management system. The power supply 28 may further include any components, such as one or more DC power supplies or AC power supplies, a recharge system, a power supply fault detection system, a power supply converter or inverter, or a power supply state indicator.

Although not illustrated, the terminal may also include a camera, a Bluetooth module and so on, which are not described here in more detail. In an embodiment, the processor 27 in the terminal 700 may store, according to the following instructions, the code of one or more applications in the memory 21, and run may the application stored in the memory 21 to realize various functions. The instructions may include the following steps.

When an executable file corresponding to a process of an application is loaded, if a first dynamic link library file is to be injected, the information of the first dynamic link library file may be added to an import table of a second dynamic link library file. For example, when the executable file corresponding to the process of the application is loaded, the processor 27 may also determine whether the execution of the process of the application utilizes an import function. In the case that the execution of the process of the application utilizes the import function, the first dynamic link library file for storing the import function may be determined

The second dynamic link library file called by the executable file may be loaded with the import table that includes the added information of the first dynamic link library file.

The second dynamic link library file may include a dynamic link library file named as mscoree and the like. The step of adding the information of the first dynamic link library file may include: constructing a new import table firstly; inserting path information of the dynamic link library file to be loaded, into the new import table, where the dynamic link library file to be loaded may include the first dynamic link library file; modify a pointer of an original import table of the second dynamic link library file, to point the pointer of the original import table to the new import table inserted with the path information.

Further, when loading the PE file corresponding to the process of the application, the processor 27 of the terminal may lock a memory space for the process of the application to prevent the loaded PE file from being modified. Thus, the processor 27 of the terminal may also jump out of the currently performed step of loading the executable file corresponding to the process of the application before adding the information of the first dynamic link library file. That is, the APC function may be executed, and then the step of the adding the information of the first dynamic link library file may be performed. Those skilled in the art may understand that all or part of the steps in the various methods of the above described embodiments may be implemented by instructing the related hardware using a program. The program may be stored in a computer readable storage medium. The storage medium may include: a Read-Only Memory (ROM), a Random Access Memory (RAM), a magnetic disk, a compact disc or the like.

Hereinbefore, a method for starting a process of an application and a computer system according to the embodiments of the disclosure are described with reference to the drawings. The principle and the embodiments of the present disclosure have been illustrated by specific examples provided herein, and the above description of the embodiments may assist with understanding the method and the core concept of the present disclosure. Meanwhile, those skilled in the art may make some variations in the embodiments according to concepts of the present disclosure. In summary, the embodiments of this description should not be interpreted as limiting the disclosure.

1. A method for starting a process of an application, comprising:
loading into memory an executable file that corresponds to the process of the application, wherein the executable file is operable to call a second dynamic link library file;
adding information of a first dynamic link library file into an import table of the second dynamic link library file in instances when it is determined that the first dynamic link library file is to be injected into the process; and
loading into memory the second dynamic link library file that includes the import table with the added information of the first dynamic link library prior to the execution of the process of the application.

2. The method according to claim 1, wherein the process of the application has a .net architecture.

3. The method according to claim 1, wherein the loading into memory the executable file that corresponds to the process of the application, wherein the executable file is operable to call the second dynamic link library file comprises:
determining whether the first dynamic link library file is to be injected into the process; and
jumping out of the step of loading into memory the executable file that corresponds to the process of the application.

4. The method according to claim 3, wherein the determining whether the first dynamic link library file is to be injected into the process further comprises:
determining whether an import function is to be applied to an execution of the process of the application; and
determining which file is the first dynamic link library file for injecting the import function in instances when it is determined that the import function is to be applied to the execution of the process of the application.

5. The method according to claim 3, wherein the jumping out of the step of loading into memory an executable file that corresponds to the process of the application includes: performing an asynchronous procedure call function.

6. The method according to claim 1, wherein the adding information of the first dynamic link library file into the import table of the second dynamic link library file comprises:
constructing a new import table, and inserting into the new import table, path information for a dynamic link library file to be loaded into memory, wherein the dynamic link library file to be loaded into memory comprises the first dynamic link library file; and
modifying a pointer of an original import table of the second dynamic link library file to point the pointer of the original import table of the second dynamic link library file, to the new import table inserted with the path information.

7. A computer system for starting a process of an application, the computer system comprising one or more hardware processors or circuits that are operable to:
in an executable file loading unit, load into memory an executable file that corresponds to the process of the application, wherein the executable file is operable to call a second dynamic link library file;
in an information adding unit, add information of a first dynamic link library file into an import table of the second dynamic link library file in instances when it is determined that the first dynamic link library file is to be injected into the process; and
in a dynamic link library file loading unit, load into memory the second dynamic link library file that includes the import table with the added information of the first dynamic link library prior to the execution of the process of the application.

8. The computer system according to claim 7, wherein the process of the application has a .net architecture.

9. The computer system according to claim 7, wherein the executable file loading unit comprises:
a determining unit adapted to determine that the first dynamic link library file is to be injected; and
a jumping unit adapted to jump out of the step of loading into memory the executable file that corresponds to the process of the application.

10. The computer system according to claim 9, wherein the determining unit is adapted to:
determine whether an import function is to be applied to an execution of the process of the application, and
determine which file is the first dynamic link library file to be injected with the import function in instances when it is determined that the import function is to be applied to the execution of the process of the application.

11. The computer system according to claim 9, wherein the jumping unit inserts an asynchronous procedure call function into an execution program for loading into memory the executable file that corresponds to the process of the application, by the executable file loading unit; and
the executable file loading unit is further adapted to perform the asynchronous procedure call function.

12. The computer system according to claim 7, wherein the information adding unit comprises:
a construction unit adapted to construct a new import table, and insert into the new import table path information of a dynamic link library file to be loaded, wherein the dynamic link library file to be loaded comprises the first dynamic link library file; and
a modification unit adapted to modify a pointer of an original import table of the second dynamic link library file to point the pointer of the original import table of the second dynamic link library file, to the new import table inserted with the path information.

13. A non-transitory machine-readable medium having stored thereon, a computer program having at least one code section for starting a process of an application, the at least one code section being executable by a machine for causing the machine to perform steps comprising:
loading into memory an executable file that corresponds to the process of the application, wherein the executable file is operable to call a second dynamic link library file;
adding information of a first dynamic link library file into an import table of the second dynamic link library file in instances when it is determined that the first dynamic link library file is to be injected into the process; and
loading into memory the second dynamic link library file that includes the import table with the added information of the first dynamic link library prior to the execution of the process of the application.

14. The non-transitory machine-readable medium of claim 13, wherein the process of the application has a .net architecture.

15. The non-transitory machine-readable medium of claim 13, wherein the loading into memory the executable file that corresponds to the process of the application, wherein the executable file is operable to call the second dynamic link library file comprises:
determining whether the first dynamic link library file is to be injected into the process; and
jumping out of the step of loading into memory the executable file that corresponds to the process of the application.

16. The non-transitory machine-readable medium of claim 15, wherein the determining whether the first dynamic link library file is to be injected into the process further comprises:
determining whether an import function is to be applied to an execution of the process of the application; and
determining which file is the first dynamic link library file for injecting the import function in instances when it is determined that the import function is to be applied to the execution of the process of the application.

17. The non-transitory machine-readable medium of claim 15, wherein the jumping out of the step of loading into memory an executable file that corresponds to the process of the application includes: performing an asynchronous procedure call function.

18. The non-transitory machine-readable medium of claim 13, wherein the adding information of the first dynamic link library file into the import table of the second dynamic link library file comprises:
constructing a new import table, and inserting into the new import table, path information for a dynamic link library file to be loaded into memory, wherein the dynamic link library file to be loaded into memory comprises the first dynamic link library file; and
modifying a pointer of an original import table of the second dynamic link library file to point the pointer of the original import table of the second dynamic link library file, to the new import table inserted with the path information.
